(19) United States
(12) Patent Application Publication
(10) Pub. No.: US 2014/0207365 A1
(43) Pub. Date: Jul. 24, 2014

(54) METHODS FOR DETERMINING A FLIGHT PATH

(71) Applicant: GE Aviation Systems LLC, (US)

(72) Inventor: Frazer Leslie Pereira, Mumbai (IN)

(73) Assignee: GE Aviation Systems LLC, Grand Rapids, MI (US)

(21) Appl. No.: 13/861,759

(22) Filed: Apr. 12, 2013

(30) Foreign Application Priority Data
Jan. 18, 2013 (IN) 140DEL2013

(51) Int. Cl. G01C 21/00

(52) U.S. Cl. CPC G01C 21/00
USPC 701/400

(57) ABSTRACT

Methods for determining a flight path for a data-collecting aircraft having a sensor may include defining a data-collecting area, subdividing the data-collecting area into zones, defining a waypoint for each of the zones to define a set of waypoints, and determining a flight path for the data-collecting aircraft incorporating the waypoints.

### CROSS-REFERENCE TO RELATED APPLICATIONS

This application claims priority under 35 U.S.C. §119 to Indian Patent Application No. 140DEL2013, filed Jan. 18, 2013, the disclosure of which is incorporated herein by reference.

### BACKGROUND OF THE INVENTION

Contemporary data-collecting aircraft may collect information over time and may be used for many tasks including traffic monitoring, mapping, geological surveying, etc. Such data-collecting aircraft may be unmanned or manned. Generally, regardless of whether the data-collecting aircraft is unmanned or manned, the aircraft will be directed in a back and forth motion over the area to be surveyed.

### BRIEF DESCRIPTION OF THE INVENTION

In one embodiment, the invention relates to a method of determining a flight path for a data-collecting aircraft having a data sensor, including defining a data-collecting area, subdividing the data-collecting area into zones based on the field of view of the data sensor, defining a waypoint for each of the zones to define a set of waypoints, and determining a flight path for the data-collecting aircraft incorporating the waypoints.

### BRIEF DESCRIPTION OF THE DRAWINGS

In the drawings:

FIG. 1 is a perspective view of an exemplary data-collecting aircraft and a ground station in which embodiments of the invention may be implemented;

FIG. 2 is a schematic view of a visual illustration of terrain and a data collecting area that may be defined according to an embodiment of the invention;

FIG. 3 is a schematic view of the data collecting area subdivided into zones according to an embodiment of the invention;

FIG. 4 is a schematic view of defined waypoints and a flight path incorporating the waypoints determined according to an embodiment of the invention; and

FIG. 5 is a schematic view illustrating how the height of the flight path may be varied according to an embodiment of the invention.

### DESCRIPTION OF EMBODIMENTS OF THE INVENTION

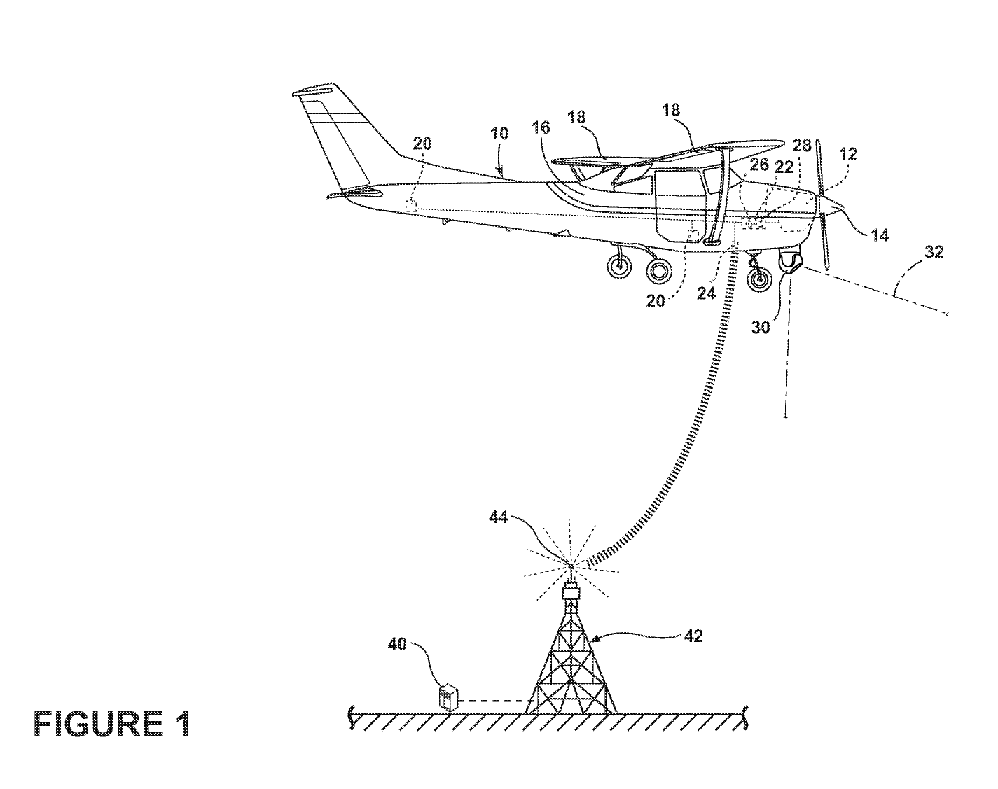

FIG. 1 depicts a data-collecting aircraft 10 that may execute embodiments of the invention and may include a propulsion system, such as an engine 12 and a propeller 14, coupled to a fuselage 16, and wing assemblies 18 extending outward from the fuselage 16. While the data-collecting aircraft 10 has been illustrated as an airplane, it is contemplated that embodiments of the invention may be used in any type of manned or unmanned aircraft, for example, without limitation, fixed-wing, rotating-wing, rocket, etc.

A plurality of systems 20 that enable proper operation of the data-collecting aircraft 10 may be included as well as a controller 22, and a communication system, which may include a wireless communication link 24. The controller 22 may be operably coupled to the engine 12, the plurality of aircraft systems 20, and the wireless communication link 24. The controller 22 may also be connected with any other controllers of the data-collecting aircraft 10. The controller 22 may include memory 26, the memory 26 may include random access memory (RAM), read-only memory (ROM), flash memory, or one or more different types of portable electronic memory, such as discs, DVDs, CD-ROMs, etc., or any suitable combination of these types of memory. The controller 22 may include one or more processors 28, which may be running any suitable programs.

A computer searchable database of information may be stored in the memory 26 and may be accessible by the processor 28. The processor 28 may run a set of executable instructions to access the database. Alternatively, the controller 22 may be operably coupled to a database of information. For example, such a database may be stored on an alternative computer or controller. It will be understood that the database may be any suitable database, including a single database having multiple sets of data, multiple discrete databases linked together, or even a simple table of data. It is contemplated that the database may incorporate a number of databases or that the database may actually be a number of separate databases. The database may store data that may include terrain information including geo-specific terrain, man-made objects, and additional data including, geo-political information and no-fly zones. The database may also include current weather conditions. All of the above mentioned data may be stored as environmental factors. The database may also include aircraft performance data.

The database may be static in its content, with standard updates, and/or may be dynamically updated during the flight of the aircraft, including updates based on the survey data collected by the aircraft.

Alternatively, it is contemplated that the database may be separate from the controller 22 but may be in communication with the controller 22 such that it may be accessed by the controller 22. For example, it is contemplated that the database may be updated through the wireless communication link 24 and that in this manner, real time information such as weather conditions may be included in the database and may be accessed by the controller 22.

Further, it is contemplated that such a database may be located off the data-collecting aircraft 10 at a location such as a control center or another location. The controller 22 may be operably coupled to a wireless network over which the database information may be provided to the controller 22. For example, the weather data may be obtained from a weather database, which may contain real-time weather data or forecasted weather data. Such weather databases may contain information regarding certain weather-related phenomena (e.g., wind speed, wind direction, temperature, among others) and data pertaining to visibility (e.g., foggy, cloudy, etc.), precipitation (rain, hail, snow, freezing rain, etc.) and other meteorological information.

A data sensor 30 may be mounted to the data-collecting aircraft 10 and has been schematically illustrated as being located at a forward portion of the data-collecting aircraft 10. It will be understood that the data sensor 30 may be mounted anywhere on the data-collecting aircraft 10, internal or external, and is preferably forward facing so that it may generate data regarding the environment located in front of the data-collecting aircraft 10 during the flight of the aircraft. The data sensor 30 may be any suitable sensor including an optical sensor having a field of view. By way of non-limiting example, the data sensor 30 may be an optical sensor such as a camera, which may be mounted on a forward portion of the data-collecting aircraft 10 in a fixed location and may generate images corresponding to the field of view 32 of the data sensor 30. Exemplary cameras include a CCD camera, a CMOS camera, a digital camera, a video camera, an infrared camera, or any other type of suitable camera for observing the external environment of the data-collecting aircraft 10. In this manner, the data sensor 30 may be capable of generating an image including at least one of a still image or a video image and outputting an image signal for same. It should be appreciated that the use of a camera is exemplary only and that other types of data sensors 30 may be employed. It is contemplated that the data sensor 30, regardless of its type, may provide any suitable type of data signal of the environment in front of the data-collecting aircraft 10 and within the field of view 32 of the data sensor 30.

While the data sensor 30 is referred to in the singular, the data sensor 30 may include multiple sensors for sensing the same or different data. In some cases, the same sensor may be distributed about the aircraft to enhance the sensing capabilities. For example, the data sensor 30 might include multiple imaging devices located on the aircraft, with each imaging device imaging the same general scene from a different perspective, such that the images may be combined to form a 3-D image.

While a data-collecting aircraft 10 has been illustrated, it is contemplated that embodiments of the invention or portions thereof may be implemented anywhere including in a computer 40 at a ground system 42. Furthermore, database(s) as described above may also be located in a destination server or a computer 40, which may be located at and include the designated ground system 42. Alternatively, the database or computer 40 may be located at an alternative ground location. The ground system 42 may communicate with other devices including the controller 22 and databases located remote from the computer 40 via a wireless communication link 44. The ground system 42 may be any type of communicating ground system 42 such as a control center.

One of the controller 22 and the computer 40 may include all or a portion of a computer program having an executable instruction set for determining a flight path for the data-collecting aircraft 10. Regardless of whether the controller 22 or the computer 40 runs the program for determining the flight path, the program may include a computer program product that may include machine-readable media for carrying or having machine-executable instructions or data structures stored thereon. Such machine-readable media may be any available media, which can be accessed by a general purpose or special purpose computer or other machine with a processor. Generally, such a computer program may include routines, programs, objects, components, data structures, algorithms, etc. that have the technical effect of performing particular tasks or implement particular abstract data types. Machine-executable instructions, associated data structures, and programs represent examples of program code for executing the exchange of information as disclosed herein. Machine-executable instructions may include, for example, instructions and data, which cause a general purpose computer, special purpose computer, or special purpose processing machine to perform a certain function or group of functions.

It will be understood that the data-collecting aircraft 10 and computer 40 merely represent two exemplary embodiments that may be configured to implement embodiments of the invention. During operation, the data-collecting aircraft 10 and/or the computer 40 may determine a flight path for the data-collecting aircraft 10 within an area of interest or data-collecting area to be surveyed for data collection. By way of non-limiting example, the controller 22 and/or the computer 40 may utilize inputs from a pilot, the database(s) and/or information from another source such as a control center to determine a flight-path for the data-collecting aircraft 10 within the area or interest. Once a flight path is determined it may be flown by the data-collecting aircraft 10. For example, if the controller 22 ran the program, then the determined flight path may be used by the autopilot of the data-collecting aircraft 10 or by a pilot of the data-collecting aircraft. In the case of an unmanned data-collecting aircraft 10 the determined flight path may be used in remote controlling the data-collecting aircraft 10. Alternatively, if the computer 40 ran the program, then the determined flight path may be uploaded or otherwise relayed to the data-collecting aircraft 10.

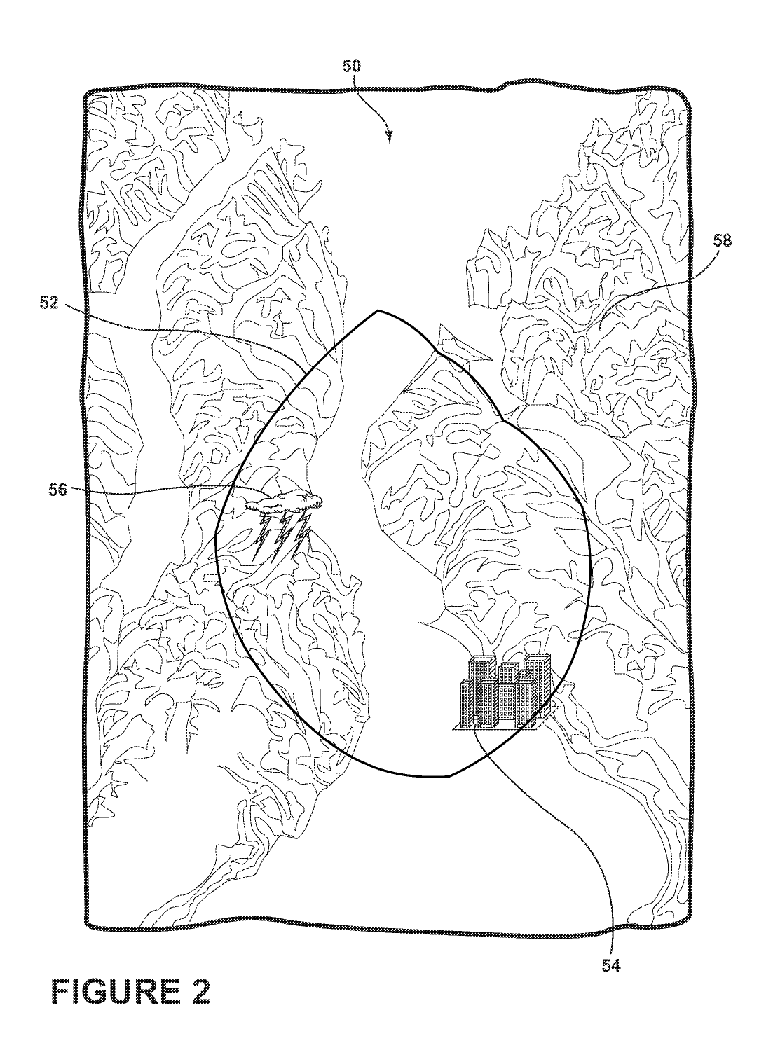

FIG. 2 illustrates a visual representation of the terrain 50 over which a data-collecting aircraft 10 may be flown. It will be understood that the visual representation may be graphically illustrated in a variety of ways and that the visual representation may take any variety of forms including a 2D map, a 3D map, a topographical map, etc. and is not germane to embodiments of the invention and is merely being used for explanatory purposes.

In determining a flight path for the data-collecting aircraft 10 embodiments of the method may include defining a data-collecting area or an area of interest 52. The area of interest 52 may be defined by a user, one or more databases, etc. For example, defining the data-collecting area may include receiving a predetermined data-collecting area from a user or otherwise. By way of non-limiting example, it is contemplated that a user may select the bounds of the area of interest 52 and that such selection may take place at a control center or other location. In the instance where such a selection is not made on the data-collecting aircraft 10, such information may be relayed to the data-collecting aircraft 10 or the computer 40. The selection of the area of interest 52 by the user may be done using any suitable technique including that a user may trace an appropriate area of interest on a user interface. Such selections techniques are not germane to the embodiments of the invention and will not be described further herein. In the illustrated example, the area of interest 52 has been illustrated as including man-made objects 54, severe weather 56, and mountainous terrain 58 such information may also be obtained from a user, a control center, or one or more databases.

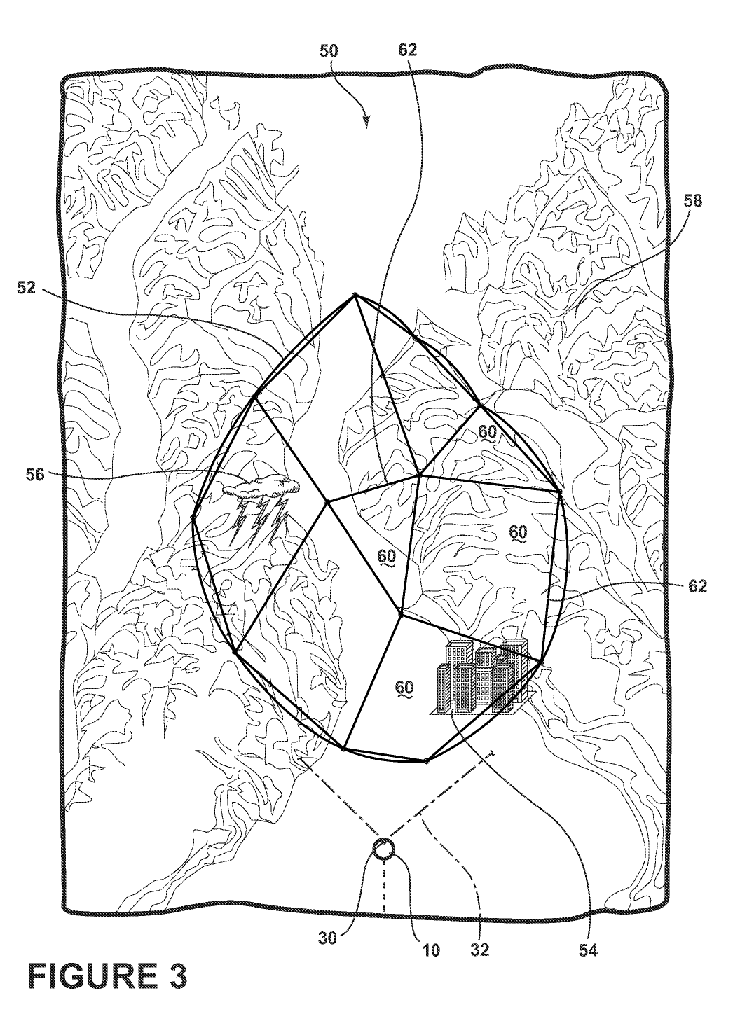

As illustrated in FIG. 3, the area of interest 52 may be subdivided into zones 60 based on the field of view 32 of the data sensor 30. It is contemplated that the zones 60 may be defined by at least one geometric shape. By way of non-limiting example, the zones have been defined by a variety of convex polygons 62. It is contemplated that the area of interest 52 may be divided into random convex polygons 62 each enclosing a region or zone 60.

The area of each of the convex polygons 62 may depend on the surveillance capabilities of the data-collecting aircraft 10 and other environmental factors which may affect the flight of the data-collecting aircraft 10. More specifically, subdividing the area of interest 52 into convex polygons 62 may take into consideration the field of view 32 of the data sensor 30 as well as the resolution offered by the data sensor 30 and the lowest flying limit of the data-collecting aircraft 10. The data-collecting aircraft 10 as well as a field of view 32 of the data sensor 30 have been schematically illustrated. It is contemplated that at least one dimension of the geometric shape, is based on the field of view 32 of the data sensor 30. For example, in the case of each of the convex polygons 62, the width of the convex polygon 62 may be no wider than what the field of view 32 of the data sensor 30 is capable of capturing.

Further, the subdivision of the area of interest 52 into zones 60 may be based on environmental factors. Such environmental factors may include terrain such as geo-specific terrain, man-made objects, geo-political information, and no-fly zones as well as weather. For example, the zones 60 may be subdivided so that thunderstorms and obstacles may be avoided.

Furthermore, the controller 22 and/or the computer 40 may take into consideration the height the data-collecting aircraft 10 is to be flown at as typically, the higher the data-collecting aircraft 10 the more the data sensor 30 may see in its field of view. By way of further example, a thunderstorm may reduce visibility requiring the data-collecting aircraft 10 to be flown lower to the ground. In such an instance, the field of view would see less so the zones 60 would need to be smaller. It will be understood that the controller 22 and/or the computer 40 may effect the subdivision of the area of interest 52 into zones 60. In implementation, the one or more environmental factors and/or the characteristics of the data sensor 30 may be converted to an algorithm, which may be converted to a computer program comprising a set of executable instructions, which may be executed by the controller 22 and/or the computer 40.

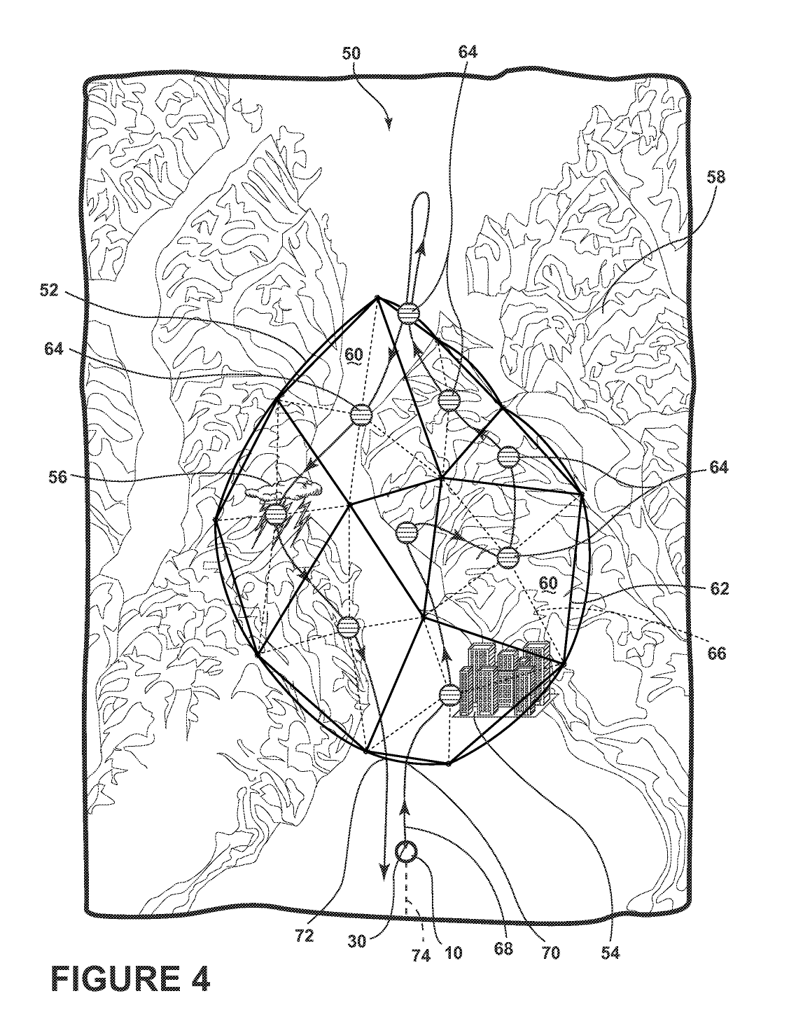

Referring now to FIG. 4, a waypoint 64 may be defined for each of the zones 60 to define a set of waypoints 64. By way of non-limiting example, each waypoint 64 has been defined at the geometric center of the geometric shape, which in the exemplary illustration is a convex polygon 62. It will be understood that the zones 60 and waypoints 64 therein may be defined or generated in any suitable manner. In the illustrated example, defining such central waypoints 64 in every convex polygon 62 allows for the data-collecting aircraft 10 when passing through each waypoint 64 to effectively cover the entire area of the zone 60 in the data-collecting run. In this manner, a secondary mesh 66 is created by the waypoints 64 allowing the data-collecting aircraft 10 to effectively cover the entirety of the area of interest 52.

A flight path 68 for the data-collecting aircraft 10, which incorporates the waypoints 64, may then be determined. It is contemplated that at least one of an entry point 70 and exit point 72 for the data-collecting aircraft 10 into the area of interest 52 may be defined before the determination of the flight path 68. In this manner, the determining the flight path 68 may be based on the at least one of the defined entry point 70 and exit point 72. For example, a user may have the ability to enter entry and exit points for the area of interest 52. Under the circumstances wherein the user does not enter the entry point 70 and exit point 72 with reference to the area of interest 52, the controller 22 and/or the computer 40 may define them based on the current location of data-collecting aircraft 10, where it is coming from, as schematically illustrated by the path 74, and environmental factors related to the area of interest 52, including environmental factors in surrounding areas.

Determining the flight path 68 for the data-collecting aircraft 10 may include applying a shortest path algorithm to the set of waypoints 64. With the entry point 70 and exit point 72 already defined, a shortest path may be derived that passes through all the defined waypoints 64. Among others, appropriate algorithms for determining the shortest path may include Dijkstra's algorithm, Bellman-Ford algorithm, A * search algorithm, Floyd-Warshall algorithm, Johnson's algorithm, etc. It is also contemplated that longer flight paths may be determined for the data-collecting aircraft 10.

Alternatively, determining the flight path 68 may include receiving a user defined flight path. In such an instance the user may manually draw the flight path 68 on the defined waypoints 64 to determine the flight path 68 for the data-collecting aircraft. In such an instance the flight path 68 may then be relayed to the data-collecting aircraft 10, which may then fly the flight path 68.

Determining the flight path 68 may also include determining the height at which the data-collecting aircraft 10 may fly during its data collecting run. The flying height may be dependent on the characteristics of the area of interest 52 including any environmental factors as well as the characteristics of the data sensor 30. In implementation, the one or more environmental factors and the characteristics of the data sensor 30 may be converted to an algorithm, which may be converted to a computer program comprising a set of executable instructions, which may be executed by the controller 22 and/or the computer 40. In this manner, the determined flight path 68 may take into consideration environmental factor such as the man-made objects 54, severe weather 56, and mountainous terrain 58. By way of non-limiting examples, the severe weather 56 may require the data-collecting aircraft 10 to be flown at a lower to obtain useable data. Further, the user may also have the option to define a minimum height which will act as a threshold for deriving the flight path.

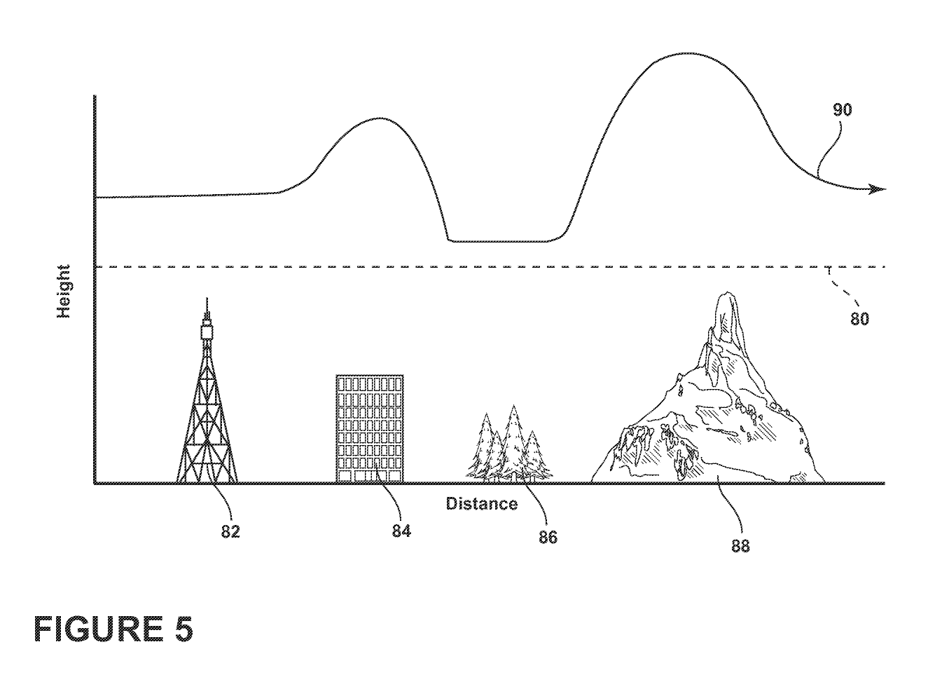

By way of non-limiting example, FIG. 5 illustrates a fixed height 80 at which the data-collecting aircraft 10 may be flown at. At such a fixed height the field of view of the sensor is constant relative to the high point within the field of view. The entire flight path 68 may be flown at this fixed height 80. Also illustrated are a variety of environmental factors including a cellphone tower 82, a building 84, trees 86, and a large hill 88. Such environmental factors may be taken into account in determining the flight path 68. As illustrated in FIG. 5, the height of the flight path may be adjusted, as indicated at 90. For example, the data-collecting aircraft 10 may fly around the cellphone tower 82 as it is relatively narrow. The data-collecting aircraft 10 may fly higher to avoid the building 84. While the data-collecting aircraft could fly around the building 84 adjusting the flight path to fly higher and over the building allows the data-collecting aircraft 10 to obtain information about the building 84. The height may be lowered above the trees 86 to allow the data-collecting aircraft to get greater detail on them. Lastly, the height of the flight path may be made much greater to allow it to fly over the large hill 88 as the data-collecting aircraft would not want to fly around the large hill 88 because it would miss collecting a variety of data.

Further, additional constraints may be considered such as a user's constraints. The user's constraints may also be considered by the controller 22 and/or the computer 40 in determining suitable locations for placement of a flight path waypoint. For example, a user's flight preferences may be one type of constraint. If the user prefers not to fly within a certain range of a mountain, then such information may be utilized in determining the suitable locations for placement of a flight path waypoint. In implementation, the information or one or more constraints may be converted to an algorithm, which may be converted to a computer program comprising a set of executable instructions, which may be executed by the controller 22 and/or the computer 40. In this manner, it is contemplated that determining the flight path may take into consideration various additional information such as undesirable to fly portions within the area of interest 52.

Once at least a portion of the flight path 68 has been determined the data-collecting aircraft 10 may be flown along at least a portion of the determined flight path 68 and collect data during the flight. Subsequently, an additional portion of the flight path 68 may be determined based on the collected data. For example, an altitude of the flight path may be determined or changed based on the collected data. In this manner, a return path may be made different based on data collected during an initial portion of a run. Alternatively, a second flight path for the data-collecting aircraft within the data-collecting area may be determined based on the data-collecting data. Thus, with the real-time information obtained from the data collection, the controller 22 and/or the computer 40 may update a remainder of the current flight path 68 and any future flight paths 68 or runs in real time. Alternatively, the user can update the constraints with reference to the information collected by the data-collecting aircraft 10.

It will be understood that the method of determining a flight path for a data-collecting aircraft is flexible and that embodiments of the method described above are merely for explanatory purposes. Further, it will be understood that while several of the Figures above reference a two dimensional terrain map the embodiments of the invention are capable of determining suitable flight paths that are three dimensional or four dimensional.

The above described embodiments provide a variety of benefits including that a flight path for a data-collecting aircraft may be efficiently and quickly determined. Further, an efficient flight path may be determined instead of requiring the aircraft to fly back and forth to survey the area. The technical effect is that the above described embodiments enable the determination of an efficient flight path which satisfies the requirements for the survey to be conducted by the data-collecting aircraft. Flight paths may be defined with respect to environmental factors while enabling a complete and accurate survey of the area of interest.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method of determining a flight path for a data-collecting aircraft having a data sensor, the method comprising:
defining a data-collecting area;
subdividing the data-collecting area into contiguous zones based on the field of view of the data sensor;
defining a waypoint within each of the zones to define a set of waypoints; and
determining a flight path for the data-collecting aircraft incorporating the waypoints.

2. The method of claim 1 wherein defining the data-collecting area comprises receiving a predetermined data-collecting area.

3. The method of claim 2 wherein the predetermined data-collecting area comprises a user defined data-collecting area.

4. The method of claim 1 wherein the zones are defined by at least one geometric shape.

5. The method of claim 4 wherein the at least one geometric shape comprises convex polygons.

6. The method of claim 4 wherein the waypoint is defined at the geometric center of the geometric shape.

7. The method of claim 4 wherein at least one dimension of the geometric shape is based on the field of view of the data sensor.

8. The method of claim 1 wherein the subdividing the data-collecting area into zones is based on environmental factors.

9. The method of claim 8 wherein the environmental factors may be at least one of terrain and weather.

10. The method of claim 1, further comprising defining at least one of an entry point and an exit point for the data-collecting aircraft into the data-collecting area.

11. The method of claim 10 wherein the determining the flight path is based on the at least one defined entry point and exit point.

12. The method of claim 1 wherein the determining the flight path comprises applying a shortest path algorithm to the set of waypoints.

13. The method of claim 1 wherein the determining the flight path comprises receiving a user defined flight path.

14. The method of claim 1, further comprising flying the data-collecting aircraft along at least a portion of the determined flight path and collecting data during the flying.

15. The method of claim 14, further comprising determining an additional portion of the flight path based on the collected data.

16. The method of claim 15 wherein an altitude of the flight path is determined based on the collected data.

17. The method of claim 14, further comprising determining a second flight path for the data-collecting aircraft within the data-collecting area based on the data-collecting data.

18. A method of determining a flight path for a data-collecting aircraft having a data sensor, the method comprising:
defining a data-collecting area based on a user defined area of interest;
subdividing the data-collecting area into contiguous convex polygons based on the field of view of the data sensor;
defining a waypoint within each of the convex polygons to define a set of waypoints;
defining entry and exit points for the data-collecting aircraft into the area of interest; and
determining a flight path for the data-collecting aircraft based on the defined entry and exits points and incorporating the defined set of waypoints.
